(19) United States
(12) Patent Application Publication
(10) Pub. No.: US 2008/0204927 A1
(43) Pub. Date: Aug. 28, 2008

(54) MAGNETIC RECORDING/REPRODUCING APPARATUS

(75) Inventors: Yoshiyuki SAITO, Osaka (JP); Hiroshi KURUMATANI, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 12/036,707

(22) Filed: Feb. 25, 2008

(30) Foreign Application Priority Data
Feb. 28, 2007 (JP) JP2007-050051

(51) Int. Cl. G11B 5/027

(52) U.S. Cl. 360/85

(57) ABSTRACT

The present invention provides a magnetic recording/reproducing apparatus including two chassis, i.e., a main chassis on which a cylinder is disposed and a sub chassis on which a cassette can be mounted. A T3 post arm is pivotally attached to the sub chassis. A groove portion capable of positioning of the T3 post arm is formed in the sub chassis. During a mid-load period until a loaded position is reached, the T3 post arm pivots to a given extent on the sub chassis to pull out the magnetic tape and is positioned by engagement of the positioning portion with the groove portion. With this configuration, it is possible to provide a magnetic recording/reproducing apparatus that makes it difficult for the tape to be damaged while having a lightweight and simple structure.

### BACKGROUND OF THE INVENTION

1. Field of the Invention

The present invention relates to a magnetic recording/reproducing apparatus that is compact, lightweight, and has excellent productivity.

2. Description of Related Art

Recently, there has been a demand for reductions in the size, weight, and cost and for an increase in the reliability of magnetic recording/reproducing apparatuses as typified by video cameras, which use tape cassettes containing magnetic tape as storage media. Hereinafter, a conventional magnetic recording/reproducing apparatus shall be described based on a configuration disclosed in JP 2004-288239A.

FIGS. 5 and 7 are plan views of the conventional magnetic recording/reproducing apparatus in a state where a cassette can be removed (hereinafter referred to as an “unloaded state”). Some components are omitted from FIGS. 5 and 7 for the sake of clarity.

A supply reel 113 and a take-up reel 119 are rotatably accommodated in a cassette 110. A magnetic tape 112 is wound around the supply reel 113 and the take-up reel 119 and extends between the supply reel 113 and the take-up reel 119. The cassette 110 of this example is a MiniDV cassette compliant with the DV format (DV:digital video). However, other types of cassettes can be used as long as the cassettes at least contain magnetic tape.

Components included in the magnetic recording/reproducing apparatus of this example are disposed on a sub chassis 118 or a main chassis 150. The main chassis 150 can be mounted on equipment (for example, a playback device), and the sub chassis 118 is disposed slidably with respect to the main chassis 150. More specifically, the sub chassis 118 is slidable on the upper face of the main chassis 150.

The cassette 110 is mounted on the sub chassis 118. The sub chassis 118 is guided by guide portions (not shown) provided on both sides of the main chassis 150 and is movable in the directions of the arrows A and B.

A supply reel stand 120 and a take-up reel stand 122 are rotatably provided on the sub chassis 118 and are engageable with the supply reel 113 and the take-up reel 119, respectively.

A tension arm 124 is provided on the sub chassis 118 so as to be pivotable on a tension arm shaft 126, and a tension post 128 is provided at one end of the tension arm 124.

FIGS. 6 and 8 show a tape reproduction or recording state (hereinafter referred to as a “loaded state”). In this state, the tension post 128 is wound with the magnetic tape 112 and controls the rotational torque of the supply reel stand 120, which is wound with a tension band 130.

A supply side boat 132 and a take-up side boat 134 can pull out the magnetic tape 112 from the inside of the cassette 110 and return the magnetic tape 112 into the cassette 110. The supply side boat 132 has an S1 post 136 disposed thereon. The take-up side boat 134 has a T1 post 138 and a T2 post 140 disposed thereon. In the loaded state shown in FIGS. 6 and 8, the magnetic tape 112 is pulled out by the supply side boat 132 and the take-up side boat 134 along guide grooves 142 and 144 and wound around the cylindrical surface of a cylinder 146.

A pinch arm 148 is supported pivotally by the main chassis 150, and a pinch roller 152 is provided at one end of the pinch arm 148. Until the loaded state shown in FIGS. 6 and 8 is reached, the pinch arm 148 pivots clockwise and presses the pinch roller 152 with a pressure spring (not shown) against a capstan shaft 156 of a capstan unit 154 provided on the main chassis 150, with the magnetic tape 112 sandwiched between the pinch roller 152 and the capstan shaft 156.

A T3 post arm 158 is supported pivotally by the sub chassis 118 via a pivoting shaft 159. A T3 post 160 is disposed at one end of the T3 post arm 158, and a cam pin 161 is formed at the other end of the T3 post arm 158. The cam pin 161 movably fits in a cam groove 151 formed in the main chassis 150. When the sub chassis 118 moves in the direction of the arrow A to place the magnetic recording/reproducing apparatus into the loaded state shown in FIGS. 6 and 8, the fit between the cam pin 161 and the cam groove 151 causes the T3 post arm 158 to pivot clockwise, so that the T3 post 160 at the tip of the T3 post arm 158 pulls out the magnetic tape 112 from the cassette 110 and winds the magnetic tape 112 around the capstan shaft 156.

The capstan unit 154 has a housing 172 in which a V-shaped groove 171 for holding and positioning a tip portion 163 of the T3 post arm 158 is formed.

When the sub chassis 118 is loaded in the direction of the arrow A, the tip portion 163 of the T3 post arm 158 moves in the direction of the arrow A and engages the V-shaped groove 171 as shown in FIGS. 9 and 10, and thus the vertical level of the T3 post arm 158 is regulated.

These sequential operations are driven by cams (not shown) during the movement of the sub chassis 118 in the directions of the arrows A and B caused by the rotation of a loading motor 152. As a result, the magnetic recording/reproducing apparatus shifts into the loaded state shown in FIGS. 6 and 8.

The capstan unit 154 has a structure in which a stator 174 of a motor is mounted on the housing 172, and the capstan shaft 154 to which a rotor 176 is attached is supported rotatably.

The capstan unit 154 is supported by the housing 172, which is mounted with screws 180 to a rear wall 178 formed at the rear face of the main chassis 150 by drawing.

FIG. 11 shows the capstan shaft 156 in the loaded state shown in FIGS. 6 and 8 as seen from the front. As shown in FIG. 11, transport of the magnetic tape 112 is controlled by rotating the housing 172 in the direction of the arrow D or E with respect to the real wall 178.

However, the configuration disclosed in JP 2004-288239A has problems. For example, during a period when the sub chassis 118 moves in the direction of the arrow A and the magnetic recording/reproducing apparatus shifts from the unloaded state to the loaded state (hereinafter referred to as a “mid-load period”), a large tension is generated in the magnetic tape 112. In such cases, a large force is generated in the T3 post 160 in the direction of the arrow F and deforms the T3 post arm 158. Moreover, the T3 post 160 is displaced from the proper position, causing damage to the tape.

Even in a normal state where a large force is not generated in the magnetic tape 112, it is necessary to maintain a precise tilt for the T3 post 160 during the mid-load period in order to avoid damage to the tape when the tape is pulled out. However, a clearance is present between the T3 post arm 158 and the pivoting shaft 159 so as to allow the T3 post arm 158 to rotate, and unevenness in this clearance makes it difficult to maintain the precise tilt for the T3 post 160 during the mid-load period. Thus, there is a problem in that it is necessary to form the parts of the pivoting shaft 159 with an extremely high dimensional precision, which results in a cost increase.

### SUMMARY OF THE INVENTION

Therefore, with the foregoing in mind, it is an object of the present invention to provide a magnetic recording/reproducing apparatus that makes it difficult for the tape to be damaged while having a lightweight and simple structure.

The magnetic recording/reproducing apparatus of the present invention is a magnetic recording/reproducing apparatus comprising a main chassis on which a cylinder having a magnetic head is disposed, a sub chassis on which a tape cassette containing a magnetic tape wound thereupon can be mounted, and tape loading members including a first tape loading member that is pivotally disposed on the sub chassis and pulls out the magnetic tape from the inside of the cassette, the tape loading member pulling out the magnetic tape from the tape cassette and winding the magnetic tape around the cylinder, the apparatus including a positioning portion formed in the first tape loading member and a positioning member formed in the sub chassis and engageable with the positioning portion, when an unloaded state is defined as a state where the tape cassette is mounted on the sub chassis with the magnetic tape not being pulled out is taken, a state where the magnetic tape is pulled out from the tape cassette by the tape loading member and wound around the cylinder is taken as a loaded position, and a period during which the sub chassis when shifting into the loaded position after being mounted with the tape cassette in the unloaded state moves relative to the main chassis in the direction toward the cylinder is taken as a mid-load period, during the mid-load period until the loaded position is reached, the first tape loading member pivots to a given extent on the sub chassis to pull out the magnetic tape and is positioned by engagement of the positioning portion with the positioning member.

According to the present invention, even when a large force is applied to the first tape loading member when the tape is pulled out, deformation of the first tape loading member can be prevented, so that it is possible to avoid damage to the tape.

Moreover, the tape loading member is not required to have a higher strength than is necessary, so that it is possible to achieve reductions in the weight and component cost.

Moreover, the tape loading member can avoid damage to the tape and does not need to be produced with high precision, so that it is possible to achieve a reduction in the production cost.

### BRIEF DESCRIPTION OF THE DRAWINGS

FIG. 1A is a plan view of a magnetic recording/reproducing apparatus according to an Embodiment. (Unloaded state)

FIG. 1B is a side view of the magnetic recording/reproducing apparatus according to the Embodiment. (Unloaded state)

FIG. 2A is a plan view of the magnetic recording/reproducing apparatus according to the Embodiment. (Mid-load state)

FIG. 2B is a side view of the magnetic recording/reproducing apparatus according to the Embodiment. (Mid-load state)

FIG. 3A is a plan view of the magnetic recording/reproducing apparatus according to the Embodiment. (Loaded state)

FIG. 3B is a side view of the magnetic recording/reproducing apparatus according to the Embodiment. (Loaded state)

FIG. 4 is a view of the magnetic recording/reproducing apparatus according to the Embodiment 1 as seen from the direction of the arrow C. (Mid-load state)

FIG. 5 is a plan view of a conventional magnetic recording/reproducing apparatus. (Unloaded state)

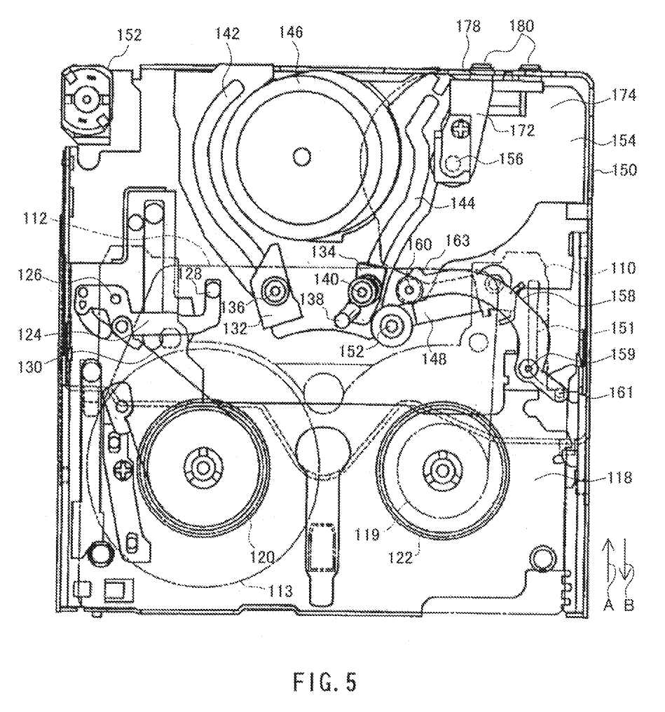

FIG. 6 is a plan view of the conventional magnetic recording/reproducing apparatus. (Loading state)

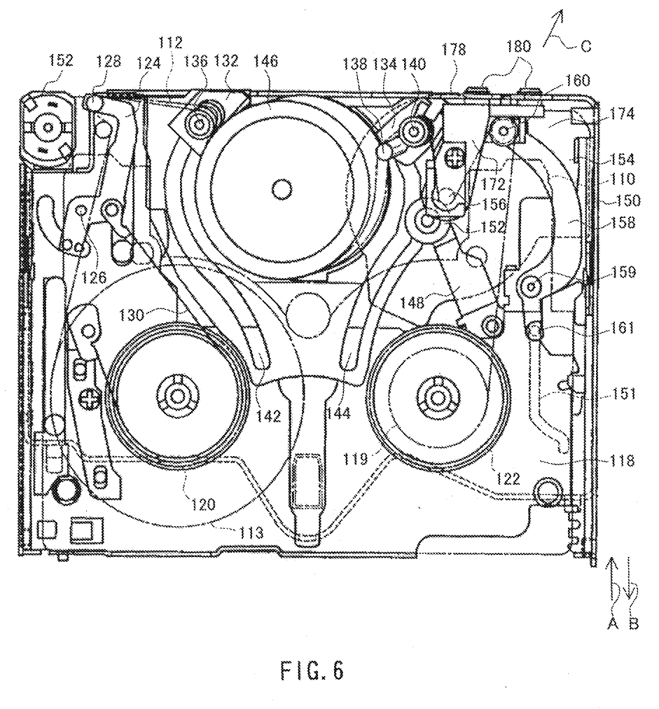

FIG. 7 is a side view of the conventional magnetic recording/reproducing apparatus. (Unloaded state)

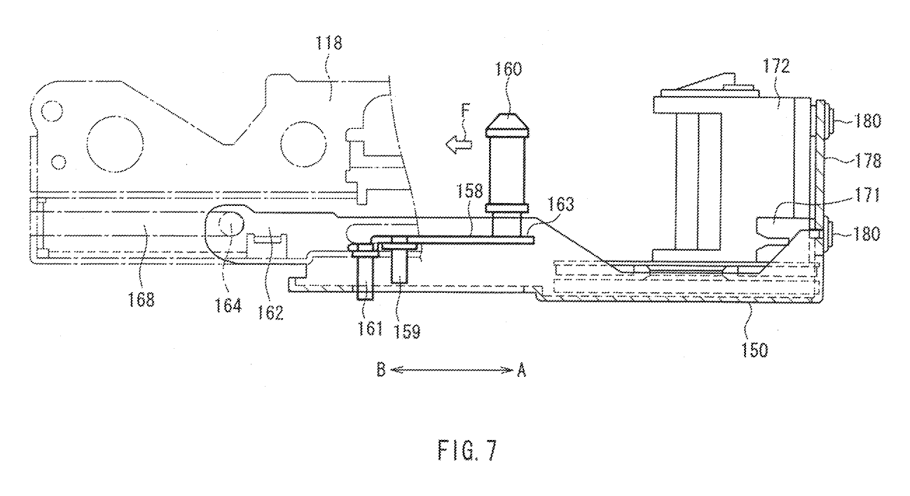

FIG. 8 is a side view of the conventional magnetic recording/reproducing apparatus. (Loading state)

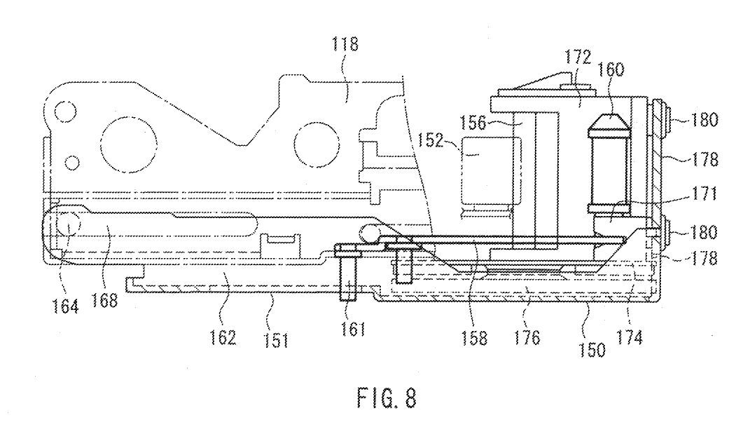

FIG. 9 is a plan view of a relevant part of the conventional magnetic recording/reproducing apparatus. (Loading state)

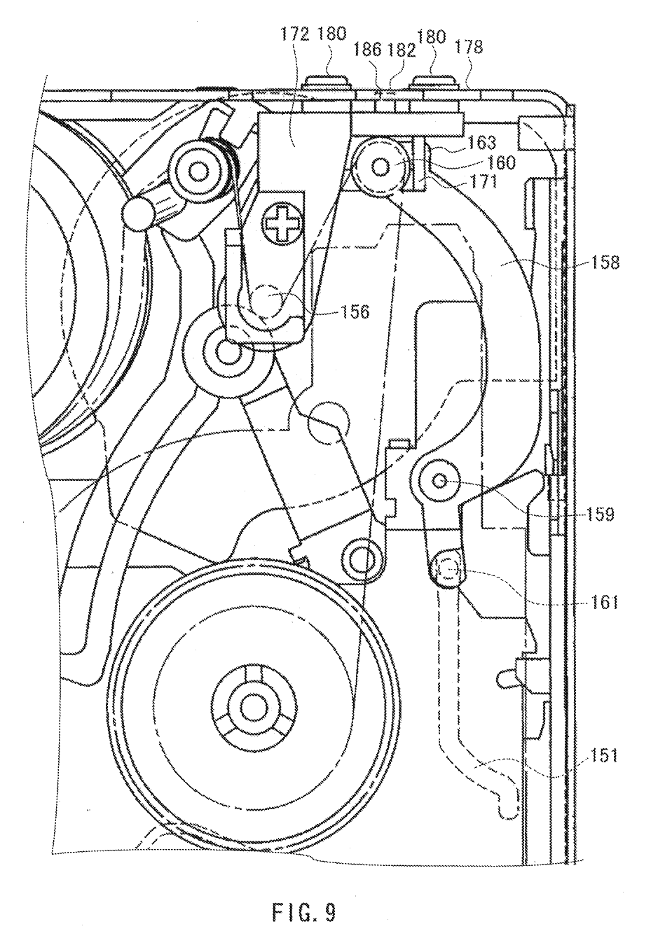

FIG. 10 is a side view of the relevant part of the conventional magnetic recording/reproducing apparatus. (Loading state)

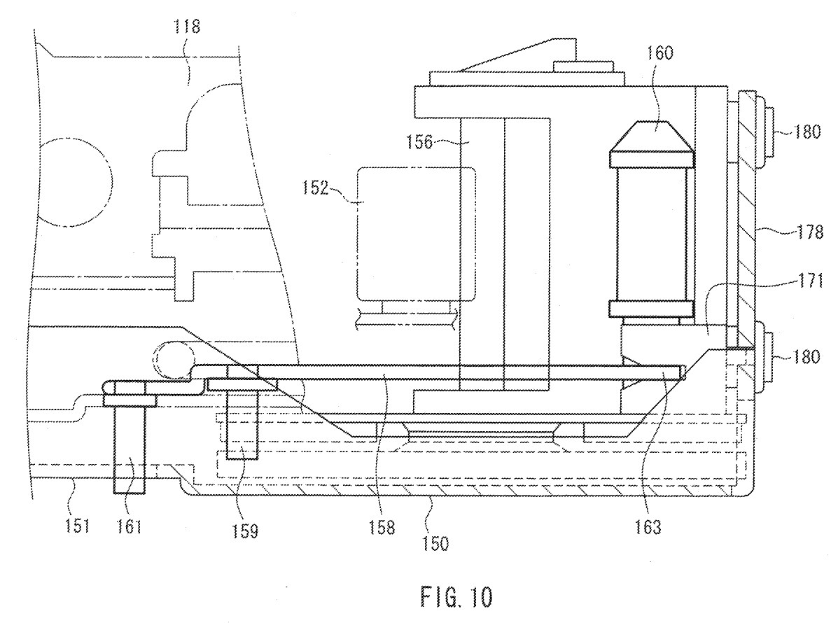

FIG. 11 is a side view of the relevant part of the conventional magnetic recording/reproducing apparatus. (Loading state)

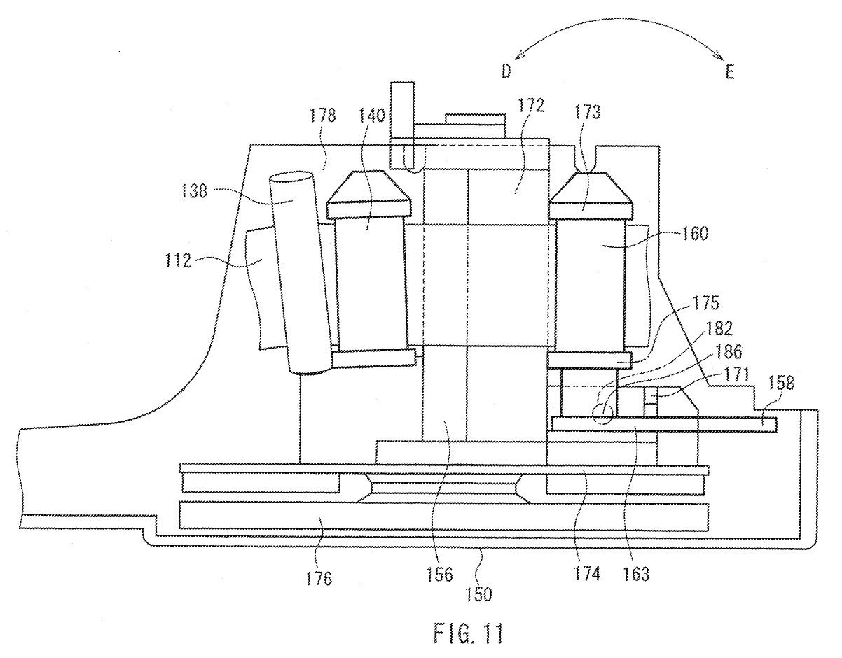

### DETAILED DESCRIPTION OF THE INVENTION

The magnetic recording/reproducing apparatus according to the present invention can have a configuration in which the first tape loading member includes an arm pivotally supported by the sub chassis and having a pivoting path almost parallel to the principal plane of the sub chassis and a post disposed at one end of the arm and around which the magnetic tape is wound, and the positioning portion is formed integrally with the arm in the vicinity of the post of the arm, and the positioning member includes a vertical wall disposed on the sub chassis upright in a direction almost perpendicular to the principal plane of the sub chassis and a groove portion formed in the wall surface of the vertical wall, and the positioning portion of the arm is brought into engagement with the groove portion during the mid-load period.

By forming the groove portion that engages the tip of the arm in the sub chassis in this manner, the arm can be held even during the mid-load period, so that deformation of the post can be prevented even when a large force acts on the post when the tape is pulled out, and thus it is possible to avoid damage to the tape during the mid-load period. Furthermore, since an abnormal force can be prevented from acting on the arm, the arm is no longer required to have a higher strength than is necessary, and thus it is possible to achieve reductions in the weight and component cost. Further still, since a precise tilt for the post during the mid-load period can be maintained without the need for a high degree of precision in a pivoting shaft portion of the arm, it is possible to avoid damage to the tape. In addition, since there is no need for a high degree of production precision, it is possible to achieve a reduction in the production cost.

Moreover, the magnetic recording/reproducing apparatus according to the present invention can have a configuration in which the groove portion is formed with an approximately V-shaped groove. With this configuration, when the arm pivots to bring the positioning portion into engagement with the groove portion, the positioning portion can be engaged securely with the groove portion. Therefore, a precise tilt for the post during the mid-load period can be maintained without the need for a high degree of precision in the pivoting shaft portion of the arm, so that it is possible to avoid damage to the tape. In addition, there is no need for a high degree of production precision, so that it is possible to achieve a reduction in the production cost.

Hereinafter, the present invention shall be described by way of an illustrative embodiment with reference to the drawings.

### Embodiment

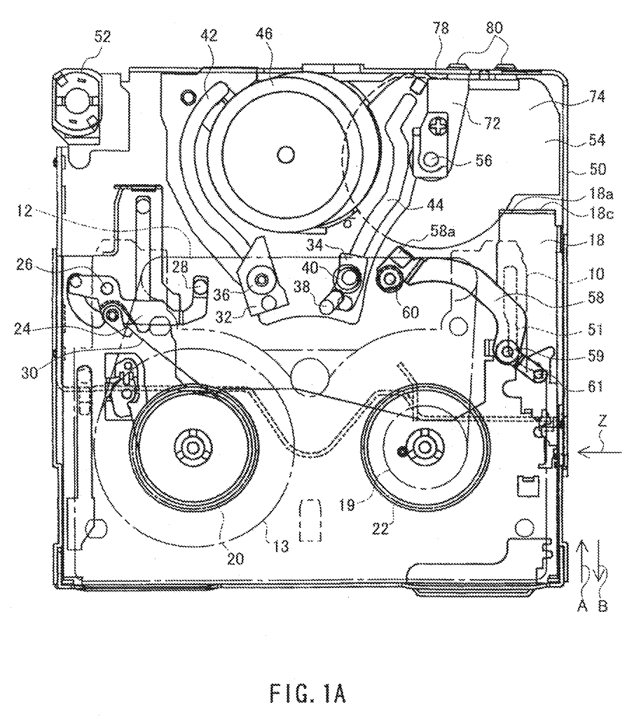

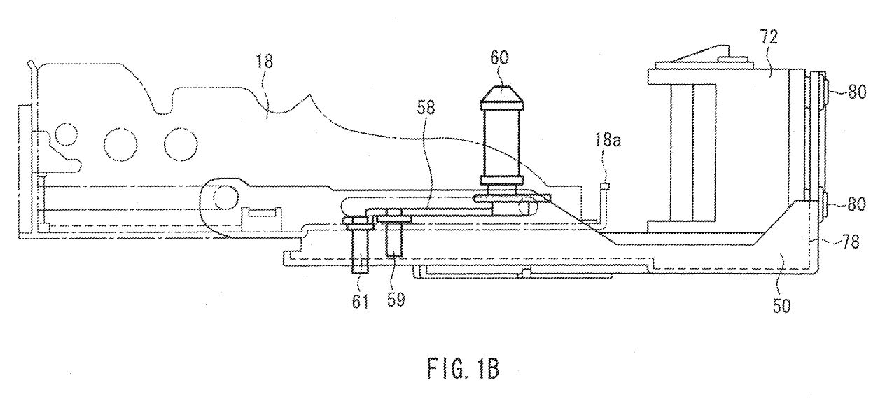

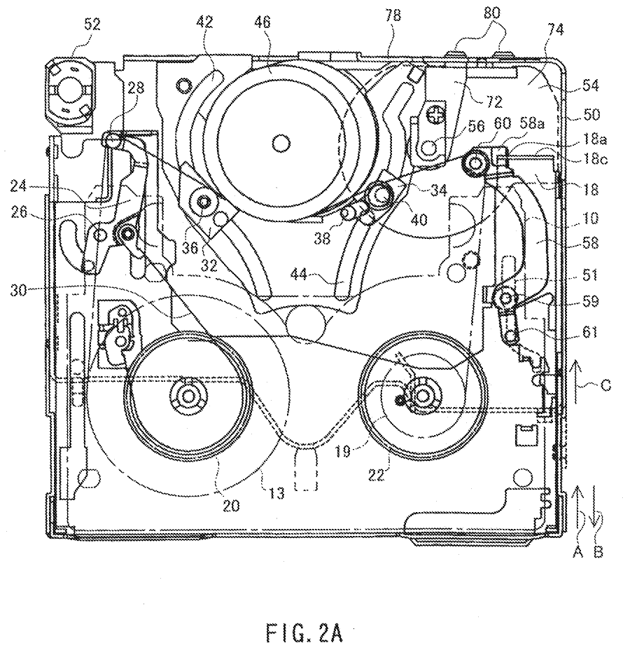

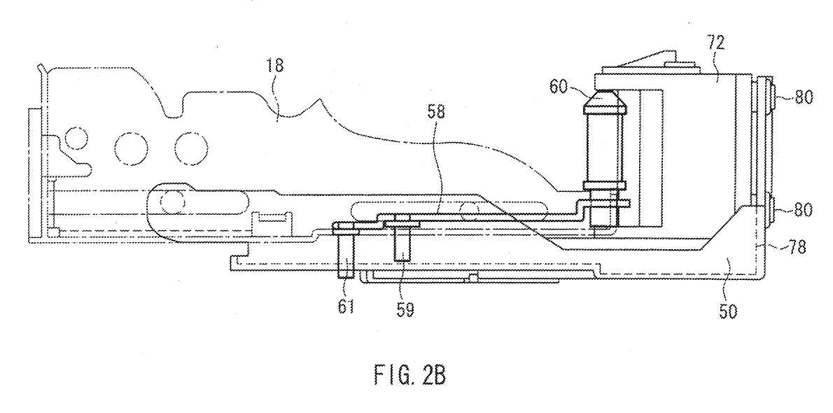

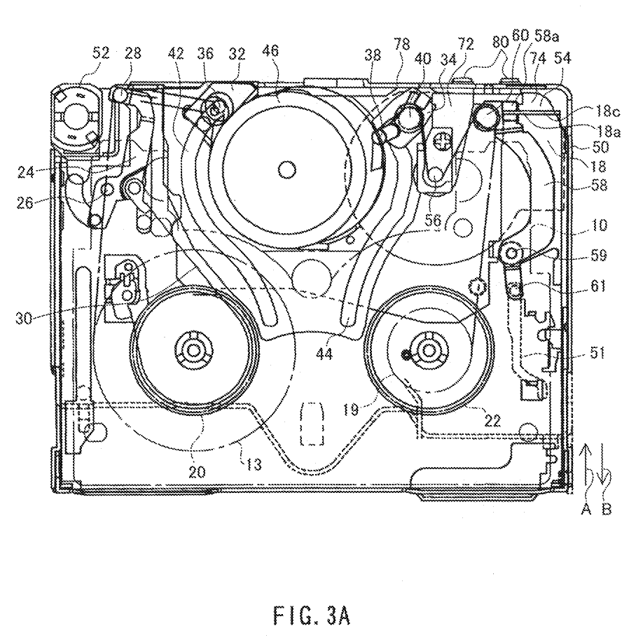

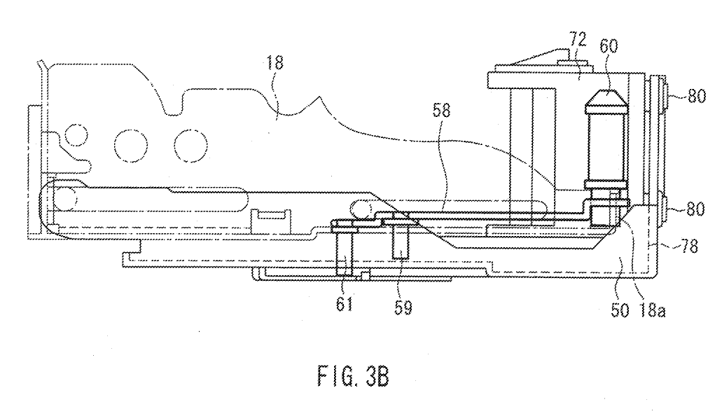

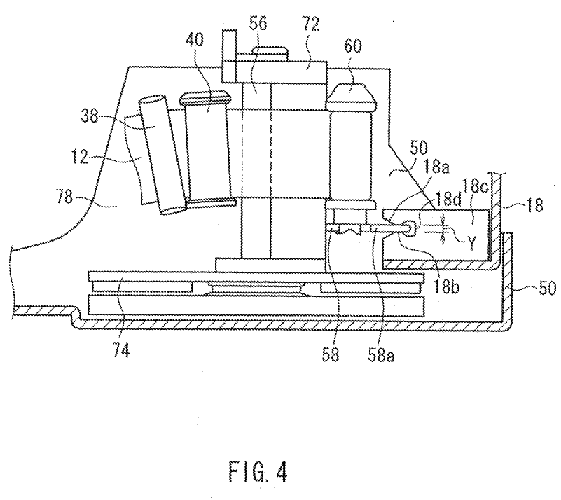

FIG. 1A is a plan view showing a magnetic recording/reproducing apparatus according to this embodiment in a state where a cassette can be removed (hereinafter referred to as an “unloaded state,” or an “unloaded position”). FIG. 1B is a side view of the magnetic recording/reproducing apparatus shown in FIG. 1A as seen from the side of the arrow Z. FIGS. 2A and 2B show a state where loading is in progress or unloading is in progress. FIGS. 3A and 3B show a state where a tape is pulled out (hereinafter referred to as a “loaded state,” or a “loaded position”). It should be noted that some components have been omitted from FIGS. 1A to 3B for the sake of clarity. FIG. 4 is a view showing the vicinity of a T3 post as seen from the direction of the arrow C in FIG. 2A. Although a T1 post 38 and a T2 post 40 in FIG. 4 are disposed on a take-up side boat 34, the take-up side boat 34 has been omitted from FIG. 4 for the sake of simplicity.

In FIGS. 1A to 3B, a supply reel 13 and a take-up reel 19 are rotatably accommodated in a cassette 10. A magnetic tape 12 is wound around the supply reel 13 and the take-up reel 19 and extends between the supply reel 13 and the take-up reel 19. The cassette 10 of this embodiment is a MiniDV cassette compliant with the DV format. However, other types of cassettes can be used as long as the cassettes at least contain magnetic tape.

Components included in the magnetic recording/reproducing apparatus of this embodiment are disposed on a sub chassis 18 or a main chassis 50. The main chassis 50 can be mounted on equipment (for example, a playback device), and the sub chassis 18 is disposed such that the sub chassis 18 is slidable in the directions indicated by the arrows A and B with respect to the main chassis 50. More specifically, the sub chassis 18 is slidable within an upper space of the main chassis 50.

The sub chassis 18 includes a groove portion 18a, a supply reel stand 20, a take-up reel stand 22, a tension arm 24, a tension arm shaft 26, a tension band 30, a T3 post arm 58, and a pivoting shaft 59. The main chassis 50 includes a supply side boat 32, the take-up side boat 34, a guide groove 42, a guide groove 44, a cylinder 46, a cam groove 51, a capstan shaft 56, a loading motor 52, a housing 72, a stator 74, a rear wall 78, and screws 80. The cassette 10 can be mounted on and removed from the sub chassis 18. The sub chassis 18 is guided by guide portions (not shown) formed on both sides of the main chassis 50 and is slidable in the directions of the arrows A and B.

The groove portion 18a is a groove having an approximate V-shape when viewed from the side and is formed in a vertical wall 18c formed in the vicinity of the position of the T3 post 60 at the time when the sub chassis 18 is in the loaded position. As shown in FIG. 4, the groove portion 18a has a slit portion 18b formed therein, the slit portion 18b having a groove width Y that allows at least a positioning portion 58a formed in the T3 post arm 58 to fit within. Moreover, the groove portion 18a is formed in an almost horizontal direction in the vertical wall 18c, which is disposed upright almost perpendicularly to the principal plane of the sub chassis 18, as shown in FIG. 4. Together, the groove portion 18a, the slit portion 18b, and the vertical wall 18c constitute a positioning member.

The supply reel stand 20 and the take-up reel stand 22 are rotatably disposed on the sub chassis 18, and when the cassette 10 is mounted on the sub chassis 18, these reel stands respectively engage the supply reel 13 and the take-up reel 19 of the cassette 10. Moreover, the supply reel stand 20 and the take-up reel stand 22 are rotated at a predetermined rotating speed by a driving force supplied from a drive source, such as a motor, provided separately. Accordingly, when the driving force is transferred in a state where the supply reel stand 20 and the take-up reel stand 22 are respectively engaged with the supply reel 13 and the take-up reel 19, the supply reel 13 or the take-up reel 19 can be rotated, and thus the magnetic tape 12 can be transported.

The tension arm 24 is pivotally supported by the tension arm shaft 26 vertically implanted in the sub chassis 18. A sliding movement of the sub chassis 18 in the direction of the arrow A causes the tension arm 24 to pivot counterclockwise central to the tension arm shaft 26, and a sliding movement of the sub chassis 18 in the direction of the arrow B causes the tension arm 24 to pivot clockwise central to the tension arm shaft 26.

A tension post 28 is disposed at one end of the tension arm 24. In a state where the magnetic tape 12 is pulled out from the cassette 10, the magnetic tape 12 is wound around the tension post 28. Moreover, in the state where the magnetic tape 12 is pulled out from the cassette 10, the pressure applied to the tension post 28 is increased or decreased as the tension of the magnetic tape 12 changes, resulting in the tension arm 24 pivoting in the clockwise or counterclockwise direction.

The tension band 30 is secured to the sub chassis 18 at one end and to the tension arm 24 at the other end, and a middle portion of the tension band 30 is wound around the supply reel stand 20. Accordingly, when the tension of the magnetic tape 12 increases and the tension arm 24 is pivoted clockwise central to the tension arm shaft 26, the braking force against the supply reel stand 20 weakens, and when the tension of the magnetic tape 12 decreases and the tension arm 24 is pivoted counterclockwise central to the tension arm shaft 26, the braking force against the supply reel stand 20 strengthens. Therefore, the rotational torque of the supply reel stand 20 can be controlled according to the tension of the magnetic tape 12.

The supply side boat 32 and the take-up side boat 34 are members for pulling out the magnetic tape 12 from the inside of the cassette 10. The supply side boat 32 has an S1 post 36 disposed thereon, and the take-up side boat 34 has a T1 post 38 and a T2 post 40 disposed thereon. Moreover, the supply side boat 32 is guided by the guide groove 42 and moves on the left side of the cylinder 46 in the drawings along the cylindrical surface of the cylinder 46. The take-up side boat 34 is guided by the guide groove 44 and moves on the right side of the cylinder 46 in the drawings along the cylindrical surface of the cylinder 46. Therefore, during a period from the unloaded state shown in FIGS. 1A and 1B up to the loaded state shown in FIGS. 3A and 3B, the supply side boat 32 and the take-up side boat 34 pull out the magnetic tape 12 from the cassette 10 along the guide grooves 42 and 44 and wind the magnetic tape 12 around the cylindrical surface of the cylinder 46. Moreover, when returning the magnetic tape 12 wound around the cylinder 46 into the cassette 10, the supply side boat 32 and the take-up side boat 34 are moved to the inside of the cassette 10 along the guide grooves 42 and 44.

The cylinder 46 has an approximately cylindrical shape and is made of a metal such as aluminum, a resin, or the like. The cylinder 46 is constituted by a stationary cylinder secured to the main chassis 50 and a rotary cylinder coaxially and rotatably disposed in the stationary cylinder. The rotary cylinder has a magnetic head that is capable of recording/reproducing signals, such as video and audio signals, to/from the magnetic tape 12 wound around the cylinder 46.

The cam groove 51b is formed in the main chassis 50, and a cam pin 61 formed on the T3 post arm 58 is movably fitted in the cam groove 51. Therefore, when the sub chassis 18 slides in the direction of the arrow A from the unloaded position, the cam pin 61 moves along the cam groove 51, and thus the T3 post arm 58 can be pivoted clockwise.

The loading motor 52 is a drive source for driving the sub chassis 18 to slide via a gear train (not shown).

A capstan unit 54 has the stator 74 of a motor secured to the housing 72, and a capstan shaft 56, to which a rotor (not shown) is attached, is rotatably supported. Moreover, the housing 72 of the capstan unit 54 is secured with the screws 80 to the rear wall 78, which is formed at the rear face of the main chassis 50 through drawing. The magnetic tape 12 is held between the capstan shaft 56 and a pinch roller (not shown), and the capstan shaft 56 can be rotationally driven so as to transport the magnetic tape 12 held between the capstan shaft 56 and the pinch roller.

The T3 post arm 58 is pivotally supported by the pivoting shaft 59 formed on the sub chassis 18. A sliding movement of the sub chassis 18 in the direction of the arrow A causes the T3 post arm 58 to pivot clockwise central to the pivoting shaft 59, and a sliding movement of the sub chassis 18 in the direction of the arrow B causes the T3 post arm 58 to pivot counterclockwise central to the pivoting shaft 59. During the mid-load period until the loaded position is reached, the T3 post arm 58 (one of the first tape loading member) pivots to a given extent on the sub chassis to pull out the magnetic tape and is positioned by engagement of the positioning portion with the positioning member. The T3 post arm 58 is having a pivoting path almost parallel to the principal plane of the sub chassis 18. The first tape loading member include the T3 post arm 58 and the T3 post 60.

The positioning portion 58a is formed in the vicinity of the T3 post 60 of the T3 post arm 58 and has a thickness that can fit in at least the groove portion 18a formed on the sub chassis 18. Moreover, when the T3 post arm 58 rotates clockwise central to the pivoting shaft 59 with the movement of the sub chassis 18 in the direction of the arrow A, the positioning portion 58a enters into the groove portion 18a, thereby providing a vertical positioning. The positioning portion 58a in this embodiment has the same thickness as the main part of the T3 post arm 58. However, the positioning portion 58a may be formed thinner than the main part of the T3 post arm 58. When the positioning portion 58a is formed in this manner, the groove width of the groove portion 18a can be reduced, so that it is possible to achieve a reduction in the size of the sub chassis 18. At the same time, the thickness of the main part of the T3 post arm 18 is not reduced, so that it is possible to ensure the flexural strength thereof.

The T3 post 60 is disposed at one end of the T3 post arm 58. The T3 post 60 is located within the tape path of the magnetic tape 12, and when the sub chassis 18 slides from the unloaded position toward the loaded position, the T3 post 60 pulls out the magnetic tape 12 from the inside of the cassette 10. Moreover, in the loaded position, the T3 post 60 is located on the exit side (take-up reel side) with respect to the capstan shaft 56. Furthermore, the T3 post 60 has flange portions formed at the upper and lower ends of a cylindrical portion thereof around which the magnetic tape 12 is wound, and the flange portions regulate the vertical position of magnetic tape 12.

The cam pin 61 is disposed at the other end of the T3 post arm 58 and protrudes downward. The cam pin 61 is engaged with the cam groove 51 provided in the main chassis 50. When the sub chassis 18 moves in the direction of the arrow A to place the magnetic recording/reproducing apparatus into a loaded state shown in FIGS. 3A and 3B, the cam pin 61 pivots the T3 post arm 58 clockwise, so that the T3 post 60 at the tip of the T3 post arm 58 pulls out the magnetic tape 12 from the cassette 10 and winds the tape around the capstan shaft 56.

Hereinafter, operations of the magnetic recording/reproducing apparatus shall be described.

First, operations of the magnetic recording/reproducing apparatus when shifting from the unloaded state shown in FIGS. 1A and 1B into the loaded state shown in FIGS. 3A and 3B shall be described. With the sub chassis 18 in the unloaded position shown in FIGS. 1A and 1B, when the loading motor 52 operates in a state where the cassette 10 is mounted on the sub chassis 18 and the supply reel 13 and the take-up reel 19 are engaged with the supply reel stand 20 and the take-up reel stand 22, respectively, the driving force generated by the loading motor 52 is transferred to the sub chassis 18 via the gear train. The sub chassis 18 is driven by the transferred driving force and starts to slide in the direction of the arrow A from the unloaded position shown in FIGS. 1A and 1B.

With the sliding operation of the sub chassis 18, the tension arm 24 is pivoted counterclockwise central to the tension arm shaft 26. Also, the T3 post arm 58 is pivoted clockwise. A detailed description of the movement of the T3 post arm 58 shall be provided later. Furthermore, the supply side boat 32 and the take-up side boat 34 start to move along the cylindrical surface of the cylinder 46 while being guided by the guide grooves 42 and 44, so that the S1 post 36, the T1 post 38, and the T2 post 40 pull out the magnetic tape 12 from the inside of the cassette 10 and start to wind the magnetic tape 12 around the cylindrical surface of the cylinder 46. The magnetic tape 12 located within the cassette 10 can thus be pulled out by these operations. FIGS. 2A and 2B show a state where pulling out of the magnetic tape 12 is in progress.

When the sub chassis 18 is further slid in the direction of the arrow A from the state shown in FIGS. 2A and 2B, the supply side boat 32 and the take-up side boat 34 reach end portions of the guide grooves 42 and 44 as shown in FIGS. 3A and 3B. Also, the S1 post 36, the T1 post 38, and the T2 post 40 wind the magnetic tape 12 around the cylindrical surface of the cylinder 46. Furthermore, the T2 post 40 and the T3 post 60 wind the magnetic tape 12 around the capstan shaft 56 due to the T3 post 60 moving to the vicinity of the rear wall 78. The magnetic tape 12 is held between the capstan shaft 56 and the pinch roller (not shown).

In the loaded state shown in FIGS. 3A and 3B, in order to record various kinds of information signals, such as video and audio signals, on the magnetic tape 12, the take-up reel stand 22 and the capstan shaft 56 are rotationally driven to transport the magnetic tape 12, and at the same time the cylinder 46 is rotated at a predetermined rotating speed. Then, the magnetic head (not shown) disposed on the rotary cylinder of the cylinder 46 is brought into sliding contact with the surface of the magnetic tape 12, and an electric current is passed through the magnetic head, thereby making it possible to record information on the magnetic tape 12. In order to reproduce information recorded on the magnetic tape 12, the magnetic tape 12 is wound around the cylinder 46 in the same manner as in the recording process described above, and the cylinder 46 is rotated. Then, an electric current is passed through the magnetic head, and changes in the magnetic flux in the magnetic tape 12 are sensed by the magnetic head, thereby making it possible to obtain reproduction signals.

In order to shift the magnetic recording/reproducing apparatus from the loaded state shown in FIGS. 3A and 3B into the unloaded state shown in FIGS. 1A and 1B, the above-described operations are performed in the reverse order. That is to say, the loading motor 52 is rotated reversely to slide the sub chassis 18 in the direction of the arrow B, and thus the movable components, such as the tension arm 24 and the T3 post arm 58, are moved to the positions shown in FIGS. 1A and 1B.

Next, movement of the T3 post arm 58 shall be described.

In FIGS. 1A and 1B, the T3 post 60 of the T3 post arm 58 in the unloaded position is located in front of the magnetic tape 12 (i.e., within the tape path) in the cassette 10. In this state, when the sub chassis 18 is driven by the driving force transferred from the loading motor 52 and moves in the direction of the arrow A, the T3 post arm 58 pivots clockwise central to the pivoting shaft 59 in accordance with this movement and pulls out the magnetic tape 12 from the inside of the cassette 10, thereby placing the magnetic recording/reproducing apparatus into the state shown in FIGS. 2A and 2B. The pivot of the T3 post arm 58 is controlled by the fit of the cam pin 61 in the cam groove 51.

In the state shown in FIGS. 2A and 2B, the positioning portion 58a of the T3 post arm 58 is guided to within the approximately V-shaped groove portion 18a and fitted into the slit portion 18b. The position of the positioning portion 58a fitted in the slit portion 18b is regulated in the vertical direction (the direction of an edge line of the sub chassis 18). FIG. 4 shows a view of the magnetic recording/reproducing apparatus in this state as seen from the direction of the arrow C. As shown in FIG. 4, positioning of the T3 post arm 58 with respect to the sub chassis 18 is achieved by inserting the positioning portion 58a of the T3 post arm 58 in the slit portion 18b of the groove portion 18a formed in the sub chassis 18. It should be noted that the groove width Y of the slit portion 18a is slightly larger than the thickness of the positioning portion 58a. The groove width Y is of such a dimension that the upper and lower faces of the positioning portion 58a are in contact with the upper and lower inner surfaces of the slit portion 18b when the positioning portion 58a is fitted in the slit portion 18b. Thus, the positioning section 58a can be securely held by the sub chassis 18.

When the sub chassis 18 further moves in the direction of the arrow A from the state shown in FIGS. 2A and 2B to place the magnetic recording/reproducing apparatus into the loaded state shown in FIGS. 3A and 3B, the T3 post 60 reaches a predetermined position (position that allows the magnetic tape 12 to be transported), and the magnetic tape 12 is wound around the cylinder 46 and the capstan shaft 56 and placed in a state where magnetic recording/reproduction is possible. It should be noted that by employing a configuration in which the tip of the positioning portion 58a in the loaded state passes through the slit portion 18b and makes contact with a slit bottom portion 18d of the vertical wall 18c, it is possible to regulate the position of the positioning portion 58a not only in the vertical direction but also in the horizontal direction (the direction of the plane of the sub chassis 18).

As described above, in this embodiment, the positioning portion 58a of the T3 post arm 58 during the mid-load period (the state shown in FIGS. 2A and 2B) is already held by the groove portion 18a formed in the sub chassis 18. Therefore, even when the tension of the magnetic tape 12 is increased when loading is in progress, and a large force is applied to the T3 post 60, deformation of the T3 post 60 and the T3 post arm 58 can be prevented because the tip of the T3 post arm 58 is positioned and held by the groove portion 18a.

Furthermore, since the tip of the T3 post arm 58 is held from when loading is in progress, a precise tilt and a precise vertical level for the T3 post 60 during this period can be maintained, so that it is possible to avoid damage to the magnetic tape 12.

Furthermore, since a precise tilt and a precise vertical level for the T3 post 60 can be maintained, it is no longer necessary to perform tilt adjustment and vertical level adjustment of the T3 post 60 and the T3 post arm 58, so that it is possible to achieve a reduction in the cost required for the adjustment.

It should be noted that the groove portion 18a does not necessarily need to have a V-shape, and the groove portion 18a serves the same function even when having another shape such as an approximate U-shape. The groove portion 18a can be formed in such a manner that the groove portion 18a has at least a shape and dimensions that can hold the positioning portion 58a.

The tip of the positioning portion 58a (the portion initially inserted in the groove portion 18a when the positioning portion 58a is inserted therein) had a rectangular shape. However, a V-shaped tip will make it possible for the positioning portion 58a to be reliably inserted in the groove portion 18a.

The magnetic recording/reproducing apparatus according to the present invention is useful for apparatuses using magnetic tape as a storage medium, and useful for video cameras, video tape recorders, and the like.

The invention may be embodied in other forms without departing from the spirit or essential characteristics thereof. The embodiment disclosed in this application is to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A magnetic recording/reproducing apparatus comprising,
a main chassis on which a cylinder having a magnetic head is disposed,
a sub chassis on which a tape cassette containing a magnetic tape wound thereupon can be mounted, and
a tape loading members including a first tape loading member that is pivotally disposed on the sub chassis and pulls out the magnetic tape from the inside of the cassette, the tape loading member pulling out the magnetic tape from the tape cassette and winding the magnetic tape around the cylinder, the apparatus further comprising:
a positioning portion formed in the first tape loading member; and
a positioning member formed in the sub chassis and engageable with the positioning portion,
wherein when an unloaded state is defined as a state where the tape cassette is mounted on the sub chassis with the magnetic tape not being pulled out is taken,
a state where the magnetic tape is pulled out from the tape cassette by the tape loading member and wound around the cylinder is taken as a loaded position, and
a period during which the sub chassis when shifting into the loaded position after being mounted with the tape cassette in the unloaded state moves relative to the main chassis in the direction toward the cylinder is taken as a mid-load period,
during the mid-load period until the loaded position is reached, the first tape loading member pivots to a given extent on the sub chassis to pull out the magnetic tape and is positioned by engagement of the positioning portion with the positioning member.

2. The magnetic recording/reproducing apparatus according to claim 1,
wherein the first tape loading member comprises:
an arm pivotally supported by the sub chassis and having a pivoting path almost parallel to the principal plane of the sub chassis; and
a post disposed at one end of the arm and around which the magnetic tape is wound, and
the positioning portion is formed integrally with the arm in the vicinity of the post of the arm, and
wherein the positioning member comprises:
a vertical wall disposed on the sub chassis upright in a direction almost perpendicular to the principal plane of the sub chassis; and
a groove portion formed in the wall surface of the vertical wall, and
the positioning portion of the arm is brought into engagement with the groove portion during the mid-load period.

3. The magnetic recording/reproducing apparatus according to claim 2, wherein the groove portion is formed with an approximately V-shaped groove.
